(19) United States
(12) Patent Application Publication
(10) Pub. No.: US 2023/0077398 A1
(43) Pub. Date: Mar. 16, 2023

(54) DETECTION DEVICE, TRACKING DEVICE, DETECTION PROGRAM, AND TRACKING PROGRAM

(71) Applicants: AISIN CORPORATION, Kariya-shi, Aichi (JP); KYUSHU INSTITUTE OF TECHNOLOGY, Kitakyushu-shi, Fukuoka (JP)

(72) Inventors: Hideo YAMADA, Tokyo (JP); Masatoshi SHIBATA, Tokyo (JP); Shuichi ENOKIDA, Iizuka-shi (JP)

(73) Assignees: AISIN CORPORATION, Kariya-shi, Aichi (JP); KYUSHU INSTITUTE OF TECHNOLOGY, Kitakyushu-shi, Fukuoka (JP)

(21) Appl. No.: 17/801,867

(22) PCT Filed: Mar. 8, 2021
(86) PCT No.: PCT/JP2021/008995

§ 371 Date: Aug. 24, 2022

(30) Foreign Application Priority Data
Mar. 6, 2020 (JP) 2020-038880

(51) Int. Cl. H04N 5/232; H04N 13/296; H04N 13/239; H04N 5/225; G06V 20/58; G06V 20/64; G06V 20/17; G06T 7/292

(52) U.S. Cl. CPC H04N 5/23299; H04N 13/296; H04N 13/239; H04N 5/2258; H04N 5/23238; G06V 20/58; G06V 20/64; G06V 20/17; G06T 7/292; G06T 2207/30196

(57) ABSTRACT

A tracking device includes full-spherical cameras arranged on the right and left. The tracking device pastes a left full-spherical camera image captured with the full-spherical camera on a spherical object, and is installed with a virtual camera inside the spherical object. The virtual camera may freely rotate in a virtual image capturing space formed inside the spherical object, and acquire an external left camera image. Similarly, the tracking device is also installed with a virtual camera that acquires a right camera image, and forms a convergence stereo camera by means of the virtual cameras. The tracking device tracks a location of a subject by means of a particle filter by using the convergence stereo camera formed in this way. In a second embodiment, the full-spherical cameras are vertically arranged and the virtual cameras are vertically installed.

### TECHNICAL FIELD

The present invention relates to a detection device, a tracking device, a detection program, and a tracking program, and relates to, for example, tracking pedestrians.

### BACKGROUND ART

In recent years, there have been actively developed robots utilized in life environments, such as hotel guidance robots, cleaning robots, and the like. Such robots have been expected especially useful in commercial facilities, factories, and nursing care services, for example, to solve labor shortages due to future population decline, living support, and the like.

In order to operate within a persons' life environment, it is necessary to grasp peripheral environments, such as a person who is a subject to be tracked and obstacles to be avoided.

Patent Literature 1 “AUTONOMOUS MOBILE ROBOT, AUTONOMOUS MOBILE ROBOT CONTROL METHOD, AND CONTROL PROGRAM” is one such technique.

This is a technique of predicting a destination of a person who is a subject to be tracked, predicting a destination of an obstacle that shields a field of view of a camera for capturing the person, and changing the field of view of the camera so that an area of the person to be captured increases when the obstacle shields the person. By the way, when a robot is used to recognize and track a person who walks, in this manner, such a person frequently and capriciously may change direction and speed within a short distance of the robot, and therefore there has been a problem how to robustly track such a person without losing sight of the person.

### CITATION LIST

### Patent Literature

Patent Literature 1: Japanese Patent Application Publication No. 2018-147337

### DISCLOSURE OF INVENTION

### Problem to be Solved by the Invention

The first object of the present invention is to reliably detect a subject.

Moreover, the second object thereof is to robustly track the subject.

### SUMMARY OF THE INVENTION(S)

(1) The invention provides a detection device installed in a traveling body, a building structure, or the like, the detection device configured to detect a predetermined subject, the detection device comprising: an image capturing means configured to captures the subject at a wide angle with an upper camera arranged at an upper side of a predetermined horizontal plane and a lower camera arranged at a lower side of the horizontal plane; and a detection means configured to detect the captured subject by performing image recognition by using each of an upper camera image of the upper camera and a lower camera image of the lower camera.
(2) The invention provides a tracking device comprising a particle generation means configured to generate particles used for a particle filter in three dimensional space on the basis of a probability distribution of a location where a subject exists, a detection device according to claim 1, a likelihood acquisition means, and a tracking means, wherein the image capturing means in the detection device captures the subject with a convergence stereo camera using the upper camera arranged at the upper side of the predetermined horizontal plane and the lower camera arranged at the lower side thereof, wherein the detection means in the detection device comprises a mapping means configured to map the generated particles to be associated with the upper camera image and the lower camera image captured respectively with the upper camera and the lower camera and an image recognition means configured to set a detection region to each of the upper camera image and the lower camera image on the basis of each location in the upper camera image and the lower camera image of the mapped particles, and perform image recognition of the captured subject by using each of the upper camera image and the lower camera image, wherein the likelihood acquisition means acquires a likelihood of the generated particles by using at least one of a first likelihood based on the image recognition of the upper camera image and a second likelihood based on the image recognition of the lower camera image; the tracking means tracks a location where the subject exists by updating the probability distribution on the basis of the acquired likelihood; and the particle generation means sequentially generates the particles on the basis of the updated probability distribution.
(3) The invention provides a detection program functioning a computer as a detection device installed in a traveling body, a building structure, or the like, the detection device configured to detect a predetermined subject, the detection program comprising: an image capturing function configured to captures the subject at a wide angle with an upper camera arranged at an upper side of a predetermined horizontal plane and a lower camera arranged at a lower side of the horizontal plane; and a detection function configured to detect the captured subject by performing image recognition by using each of an upper camera image of the upper camera and a lower camera image of the lower camera.
(4) The invention provides a tracking program implementing functions by using a computer, the functions including: a particle generation function configured to generate particles used for a particle filter in three dimensional space on the basis of a probability distribution of a location where a subject exists; an image capturing function configured to capture the subject with a convergence stereo camera using an upper camera arranged at an upper side of the predetermined horizontal plane and a lower camera arranged at a lower side thereof; a mapping function configured to map the generated particles to be associated with an upper camera image and a lower camera image captured respectively with the upper camera and the lower camera; an image recognition function configured to set a detection region to each of the upper camera image and the lower camera image on the basis of each location in the upper camera image and the lower camera image of the mapped particles, and perform image recognition of the captured subject by using each of the upper camera image and the lower camera image; a likelihood acquisition function configured to acquire a likelihood of the generated particles by using at least one of a first likelihood based on the image recognition of the upper camera image and a second likelihood based on the image recognition of the lower camera image; and a tracking function configured to track a location where the subject exists by updating the probability distribution on the basis of the acquired likelihood, wherein the particle generation function sequentially generates the particles on the basis of the updated probability distribution.

### Effect of the Invention(s)

According to the detection device according to claim 1, since each the upper camera arranged at the upper side of the predetermined horizontal plane and the lower camera arranged at the lower side of the horizontal plane perform image recognition to detect the captured subject, the subject can be reliably detected.

According to the tracking device according to claim 2, the subject to be tracked can be robustly tracked by generating the particles in the three dimensional space where the subject exists, and updating the probability distribution of the location of the subject to be tracked.

### BRIEF DESCRIPTION OF DRAWINGS

FIG. 1 are diagrams illustrating an example of an appearance of a tracking robot according to a first embodiment.

FIG. 2 is a diagram illustrating a hardware configuration of a tracking device.

FIG. 3 are diagrams for describing a virtual camera configured to capture a stereo image.

FIG. 4 are diagrams for describing a method of measuring a distance and an orientation to a subject.

FIG. 5 are diagrams for describing superiority of a convergence stereo method.

FIG. 6 are diagrams for describing a method of generating particles.

FIG. 7 are diagrams for describing mapping of particles over a camera image.

FIG. 8 are diagrams for describing a method of tracking a location of a subject with a virtual camera.

FIG. 9 are diagrams for describing a method of calculating a likelihood.

FIG. 10 is a flow chart for describing tracking processing.

FIG. 11 are diagrams illustrating an example of an appearance of a tracking robot according to a second embodiment.

FIG. 12 are diagrams for describing a survey method used in the second embodiment.

### BEST MODE(S) FOR CARRYING OUT THE INVENTION

### (1) Outline of Embodiments

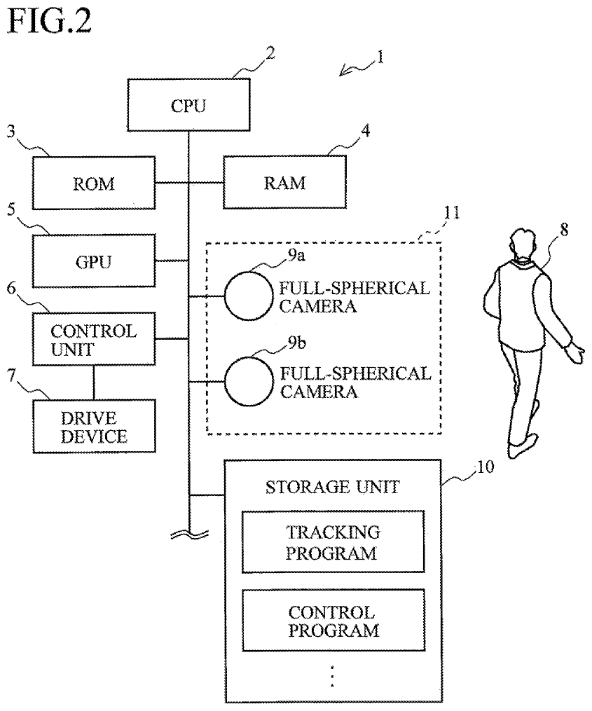

A tracking device 1 (FIG. 2) is includes full-spherical cameras 9a, 9b arranged on the right and left of a tracking robot.

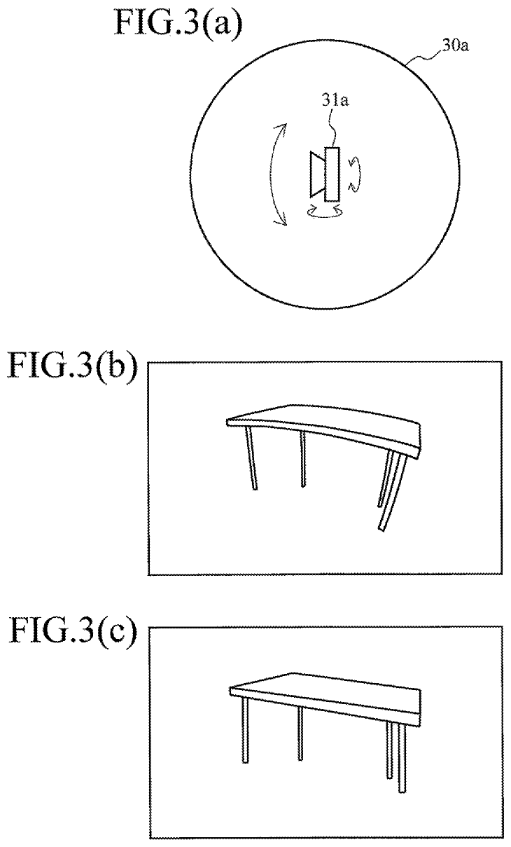

The tracking device 1 pastes a left full-spherical camera image captured with the full-spherical camera 9a on a spherical object 30a (FIG. 3(a)), and is installed with a virtual camera 31a inside the spherical object 30a (FIG. 3(a)).

The virtual camera 31a may freely rotate in a virtual image capturing space formed inside the spherical object 30a, and acquire an external left camera image.

Similarly, the tracking device 1 is also installed with a virtual camera 31b that acquires a right camera image from a right full-spherical camera image captured with the full-spherical camera 9b, and forms a convergence stereo camera by means of the virtual cameras 31a, 31b.

The tracking device 1 tracks a location of a subject 8 by means of a particle filter by using the convergence stereo camera formed in this way.

The tracking device 1 generates particles three dimensionally in a space where the subject 8 exists. However, since the subject 8 is assumed to be a pedestrian and moves in parallel with a walking surface, the tracking device 1 generates a large number of particles around a circular region 32 centered on the subject 8 in a plane parallel to the walking surface at a height of an approximate torso of the subject 8.

Then, the tracking device 1 acquires the left camera image and the right camera image respectively with the virtual cameras 31a, 31b, maps the particles generated in a real space where the subject 8 walks to be in association with the right and left camera images.

In other words, the generated particles are respectively projected onto the right and left camera image, and the mapped particles are associated with the left camera image and the right camera image so that these are identified as the same particles in the three dimensional space.

Subsequently, the tracking device 1 sets a detection region for each of the left camera image and the right camera image on the basis of the mapped corresponding particles, and image recognizes the subject 8 in each of the left camera image and the right camera image.

The tracking devices 1 obtains a likelihood of particles generated in the real space where the subject 8 exists on the basis of a likelihood in the left camera image and a likelihood in the right camera image from a result of the image recognition. For example, a tracking device 1 averages the likelihood in the left camera image and the likelihood in the right camera image to obtain the likelihood of the particles generated in the real space where the subject 8 exists.

In this way, the tracking device 1 calculates the likelihood of each particle generated around the subject 8 in the real space and weights each particle on the basis of the likelihood. In accordance with this distribution of weighting, a probability distribution of the location where the subject 8 exists can be obtained.

By means of this probability distribution, it is possible to estimate in what space (i.e., the space where the torso exists since the particles are scattered at the approximate height of the torso) and with what probability the subject 8 exists in the three dimensional real space.

Consequently, the location of the subject 8 (where a probability density is high) can be acquired.

The tracking device 1 then resamples the subject 8 to update the probability distribution, by adopting particles having large weight into resampling and deleting particles having small weight.

In other words, many particles are randomly generated around the particles having large weight, and no particles are generated (or fewer particles are generated) for the particles having small weight.

Consequently, a distribution of a particle density (concentration) corresponding to the current probability distribution of the subject 8 can be acquired.

The tracking device 1 newly acquires right and left images and calculates a likelihood of these newly generates particles to update the weight. Consequently, the probability distribution is updated.

This tracking device 1 can track the current location (i.e., the latest probability distribution) of the subject 8 by repeating such processing.

the tracking device 1 tracks the location having a high probability of the subject 8 existing by means of the particle filter that repeatedly generates particles, observes the likelihood, weights the particles, and resamples them.

Then, the tracking device 1 calculates a distance d to the subject 8 and an angle θ at which the subject 8 exist by convergently viewing and surveying a location having a high probability of the subject 8 existing with the virtual cameras 31a, 31b, and controls movement of the tracking robot on the basis thereof.

It is to be noted that the location of the subject 8 is represented by a cylindrical coordinate system of (d, θ, height z), but since the height z of a pedestrian is considered to be constant, the location of the subject 8 is represented by (d, θ).

In a second embodiment, the full-spherical cameras 9a, 9b are vertically arranged and the virtual cameras 31a, 31b are vertically installed.

A pedestrian environment of the subject 8 can be captured and surveyed in 360 degrees without a blind spot by installing the virtual cameras 31a, 31b above and below.

### (2) Details of Embodiments

### First Embodiment

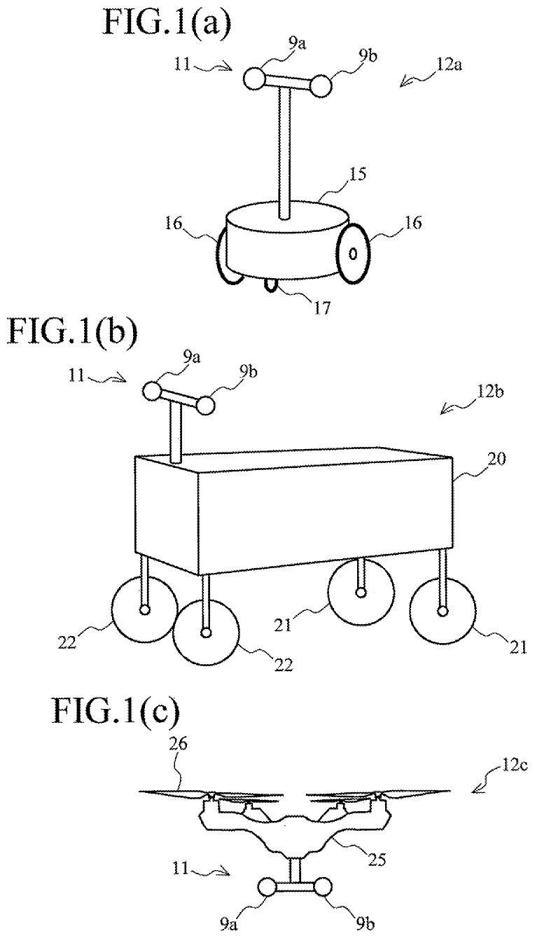

Each diagram in FIG. 1 is a diagram illustrating an example of an appearance of a tracking robot 12 according to the first embodiment.

The tracking robot 12 is an autonomous mobile tracking robot that recognizes a subject to be tracked and tracks this subject from behind.

Hereinafter, such a subject to be tracked is mainly assumed to be as a pedestrian. This is merely one example and the subject to be tracked can be assumed to be other mobile objects, such as a vehicle or a flying body such as a drone.

FIG. 1(a) illustrates an example of a tracking robot 12a compactly configured with a tricycle, with a main purpose of tracking itself.

For example, it is possible to watch over children or elderly people walking around, follow a person in charge to enter a work site or disaster site to collect information, track and observe animals such as livestock, track and observe a subject to prevent him/her from entering limited areas, and so on.

The tracking robot 12a includes a cylindrical housing 15 including a pair of rear wheels 16 constituting driving wheels and one front wheel 17 configured to change direction and guide the tracking direction.

In addition, these wheels may be an endless track used in a bulldozer or the like, or may have a leg structure such as an insect's arthropod.

A columnar member whose height is an approximate pedestrian's torso is stood vertically above near the center of an upper surface of the housing 15, and an image capturing unit 11 is provided at the tip thereof.

The image capturing unit 11 includes two full-spherical cameras 9a, 9b installed approximately 30 centimeters apart from each other in a horizontal direction. Hereinafter, unless otherwise distinguished, it is simply be abbreviated as a full-spherical camera 9, and the same will be applied to the other components.

The full-spherical cameras 9a, 9b are each configured by combining a fisheye lens, and can acquire a 360-degree field of view. A tracking device 1 (FIG. 2) mounted on the tracking robot 12a stereoscopically views a subject to be tracked with virtual cameras 31a, 31b configured to cut out a planar image from each full-spherical camera image captured with the full-spherical cameras 9a, 9b, and surveys a distance and an orientation (angle, direction) to the subject to be tracked by means of triangular surveying.

The tracking robot 12a moves behind the subject to be tracked on the basis of the aforementioned survey result, and follows this subject.

Inside the housing 15, there are contained a computer constituting the tracking device 1, a communication device for communicating with a server, a mobile terminal, and the like, a battery for supplying power, a drive device for driving the wheels, and the like.

FIG. 1(b) illustrates an example of a tracking robot 12b provided with a loading function.

The tracking robot 12b includes a housing 20 of which a travelling direction is the longitudinal direction. The housing 20 contains a computer, a communication device, a battery, a drive device, and the like, and further can be equipped with, for example, a loading platform, a storage box, and a saddle-shaped seat.

An image capturing unit 11 similar to that of the tracking robot 12a is provided at a tip portion of an upper surface of the housing 20.

Furthermore, the tracking robot 12b includes a pair of rear wheels 21 constituting driving wheels and a pair of front wheels 22 that change direction and guide the tracking direction. These wheels may be an endless track or may have leg structure.

The tracking robot 12b can, for example, assist in carrying loads or carry a person on the seat. Moreover, it may be configured so that, for a plurality of tracking robots 12b, the topmost tracking robot 12b tracks a subject to be tracked, and the remaining tracking robots 12b follow the tracking robot 12b in front of each of them. Thereby, a plurality of tracking robots 12b can be configured to be connected to one another to travel in parallel by software. This allows one guide to carry many loads.

FIG. 1(c) illustrates an example on which a tracking robot 12c is mounted on a drone.

A plurality of propellers 26 for floating the tracking device 1 are provided on an upper surface of the housing 25, and an image capturing unit 11 is suspended under a bottom surface thereof. The tracking robot 12c tracks a target, while floating and flying in the air.

For example, when a cold is spreading, it is possible to track people who are not wearing masks and call attention from a mounted loudspeaker, such as “Let's wear a mask.”

FIG. 2 is a diagram illustrating a hardware configuration of the tracking device 1.

The tracking device 1 is configured by connecting, with a bus line, a Central Processing Unit (CPU) 2, a Read Only Memory (ROM) 3, a Random Access Memory (RAM) 4, a Graphics Processing Unit (GPU) 5, an image capturing unit 11, a storage unit 10, a control unit 6, a drive device 7, and the like.

The tracking device 1 three dimensionally tracks a location of the subject 8 by image recognition using a stereo camera image. Herein, a pedestrian is assumed as the subject 8.

The CPU 2 image recognizes the subject 8 and surveys the location thereof in accordance with a tracking program stored in the storage unit 10, and issues a command to the control unit 6 to move the tracking robot 12 in accordance with a control program.

The ROM 3 is a read only memory for storing basic programs, parameters, and the like, to operate the tracking device 1 by the CPU 2.

The RAM 4 is a readable/writable memory for providing a working memory to perform the above described processing by the CPU 2.

The image captured by the image capturing unit 11 is developed in the RAM 4 and is used by the CPU 2.

The GPU 5 is an arithmetic unit having a function of simultaneously performing a plurality of calculations in parallel, and is used for performing high-speed parallel processing of image processing for each particle based on a large number of generated particles, in the present embodiment.

The image capturing unit 11 is configured by using full-spherical cameras 9a, 9b capable of acquiring a color image of 360 degrees around at once.

The full-spherical cameras 9a, 9b are installed apart from each other at a predetermined distance (in this case approximately 30 centimeters) in the horizontal direction, and acquire an image obtained by stereoscopically viewing the subject 8.

When the subject 8 is in front of the tracking device 1, the full-spherical camera 9a is located at a left side of the subject 8 and the full-spherical camera 9b is located at a right side thereof. When the subject 8 turns behind the tracking device 1, the right and left sides thereof are reversed.

Since the full-spherical cameras 9a, 9b are wide-angle cameras having a 360-degree field of view, the tracking device 1 includes a wide-angle image acquisition means for acquiring a left wide-angle image and a right wide-angle image respectively from a left wide-angle camera and a right wide-angle camera in this manner. Accordingly, these left wide-angle camera and right wide-angle camera are respectively constituted of a left full-spherical camera (the full-spherical camera 9a when the subject 8 is located in front of the tracking robot 12), and a right full-spherical camera (the full-spherical camera 9b). Even if the fields of view of these wide-angle cameras are equal to or less than 360 degrees, the tracking device 1 can be configured although the tracking range is limited.

In the following, there will now be described a case where the subject 8 is in front of the tracking device 1, and it is assumed that the full-spherical camera 9a captures the subject 8 from the left side and the full-spherical camera 9b captures the subject 8 from the right side.

When the subject 8 is located at the back surface side of the tracking device 1, the left and right sides of the description may be read as right and left thereof.

The drive device 7 is configured of a motor for driving the wheels, and the like, and the control unit 6 controls the drive device 7 on the basis of a signal supplied from the CPU 2 and adjusts a travelling speed, a turning direction, and the like.

Each diagram in FIG. 3 is a diagram for describing a virtual camera configured to capture a stereo image of the subject 8.

The full-spherical camera 9a is configured by combining two fisheye lenses, and constructs two fisheye camera images as one sphere by pasting a left full-spherical camera image captured by these two fisheye lenses on a surface of a spherical object 30a illustrated in FIG. 3(a).

Consequently, an object as a globe having a surface becoming a 360-degree view around the full-spherical camera 9a is formed.

Then, the virtual camera 31a configured of a virtual pinhole camera is installed inside the spherical object 30a and this is virtually rotated by software. Accordingly, it is possible to acquire a left camera image having reduced distortion similar to a view captured by a monocular camera for around observed in the image capturing direction of the virtual camera 31a.

The virtual camera 31a can be freely rotated continuously or discretely in the spherical object 30a to select the image capturing direction.

Consequently, as illustrated by the arrows, the virtual camera 31a can be panned or tilted by an arbitrary amount in an arbitrary direction in the spherical object 30a.

In this way, the inside of the spherical object 30a is a virtual image capturing space of the virtual camera 31a.

Since the virtual camera 31a is formed by software, it is not affected by the law of inertia and can control the image capturing direction without any machine mechanism. Therefore, the image capturing direction can be instantly switched continuously and discretely.

In addition, it is also possible to install a plurality of virtual cameras 31a in the spherical object 30a to independently rotate these cameras to simultaneously acquire left camera images in a plurality of image capturing directions.

For example, although a case where a single subject 8 is tracked is described in the following, it is also possible to form as many the virtual cameras 31a, 31a, . . . as the number of subjects 8, and to track multiple subjects independently and simultaneously.

Although the full-spherical camera 9a has been described above, but the same may also be applied to the full-spherical camera 9b.

Although not illustrated, a right full-spherical camera image is acquired with the full-spherical camera 9b and is pasted on the spherical object 30b, and an around view can be captured with the virtual camera 31b in the virtual image capturing space.

The left full-spherical camera image is composed of a fisheye lens image, and therefore a straight line portion of a desk is curved in an image of the desk illustrated in an example of FIG. 3(b). For example, the left full-spherical camera image is composed of fisheye lens images of, such as an equidistant projection method in which a distance and angle from the center of the screen are proportional to each other.

When this is captured with the virtual camera 31a, a left camera image of the desks having reduced distortion can be obtained, as illustrated in FIG. 3(c). In this way, since a two dimensional camera image used in general image recognition can be obtained by using the virtual camera 31a, a normal image recognition technique can be applied.

The same may also be applied to the right full-spherical camera image, and when the virtual camera 31b is used, a two dimensional camera image used in the normal image recognition can also be acquired.

In the present embodiment, although the virtual cameras 31a, 31b are configured of virtual pinhole cameras, this is merely one example, and it may use other methods of converting the fisheye lens image into a planar image.

The virtual cameras 31a, 31b used herein function as an image capturing means of capturing the subject.

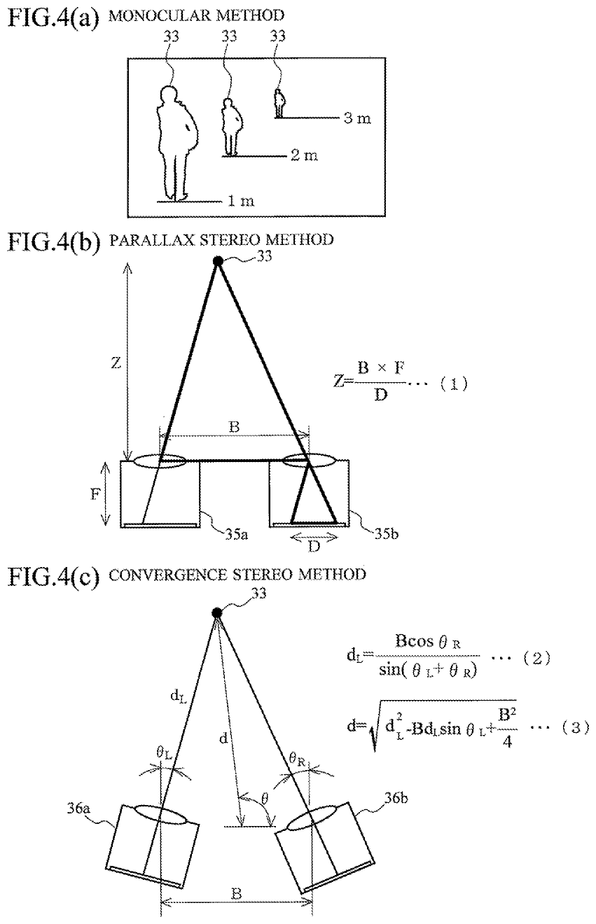

Each diagram in FIG. 4 is a diagram for describing a method of measuring a distance and an orientation to a subject using cameras.

The tracking device 1 needs to measure a location of the subject 8 in a three dimensional space (pedestrian space) using cameras in order to track the subject 8.

There are mainly the following three methods for such a measurement method.

FIG. 4(a) is a diagram illustrating a measurement method by means of geometric correction.

In the geometric correction according to a monocular method, the distance is obtained in accordance with an installation location of a monocular camera and a geometric state of a subject 33 (how the subject is captured) in a camera image.

For example, the distance to the subject 33 can be found in accordance with a standing position of the subject 33 with respect to a base of the camera image, and the horizontal lines illustrate the standing positions when the distances to the subject 33 are 1 meter, 2 meters, and 3 meters in an example of the diagram.

Moreover, an orientation where the subject 33 exists can be obtained on the basis of a left-right position on the above mentioned horizontal line of the camera image.

FIG. 4(b) is a diagram illustrating a measurement method by means of parallax stereo (compound eye).

In the parallax stereo method, a pair of front-facing camera 35a (left camera) and camera 35b (right camera) is fixed at a predetermined distance between left and right sides, and stereoscopic viewing and triangular surveying is performed on the subject 33 by parallax from the cameras 35a, 35b with respect to the subject 33.

As illustrated in the diagram, the parallax stereo method can obtain the distance and orientation to the subject 33 from a similarity relationship between the larger triangle illustrated by the thick line connecting the subject 33 and the baseline and the smaller triangle illustrated by the thick line connecting the base due to the parallax formed on the imaging surface and the center of the lens.

For example, Z is expressed by the equation (1), where Z is the distance to the subject, B is the baseline length, F is the focal length, and D is the parallax length. The orientation can also be obtained on the basis of the similarity relationship.

FIG. 4(c) is a diagram illustrating a measurement method by means of a convergence stereo method.

The term convergence means an operation of performing the so-called close-set eyes, and the subject 33 is stereoscopic viewed and surveyed by convergently viewing the subject 33 with a pair of the camera 36a (left camera) and camera 36b (right camera) disposed at a predetermined distance between right and left sides.

As illustrated in the diagram, each of the image capturing directions of the right camera and the left camera is directed to the subject 33 in the convergence stereo method, dL is expressed by the equation (2) on the basis of a geometric relationship and thereby d can be obtained by the equation (3), where B is the baseline length, dL is the distance from the left camera to the subject 33, θL is the angle between the optical axis of the left camera lens and the front direction, θR is the angle between the optical axis of the right camera lens and the front direction, θ is the orientation of the subject 33 with respect to the convergence stereo cameras, d is the distance from the convergence stereo cameras to the subject 33. The angle θ corresponding to the orientation can similarly be obtained on the basis of the geometric relationship.

It is to be noted that, in order to prevent the character codes from an erroneous conversion (the so-called garbled characters), the subscript characters and the superscript characters expressed in the drawing are expressed as normal characters. The same may be applied to the other mathematical expressions described in the following.

As mentioned above, any of the three types of measurement methods are available, but the convergence stereo method is superior in pedestrian tracking among these measurement methods and exhibits outstanding capability, as described in the following, the convergence stereo method is adopted in the present embodiment.

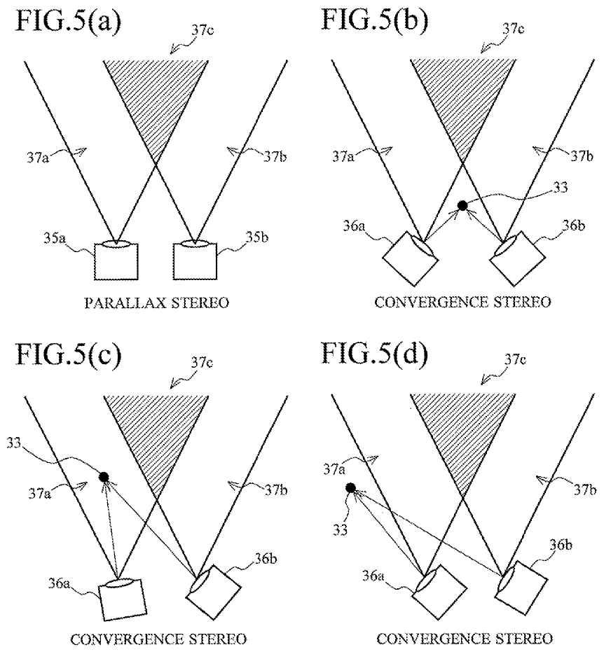

FIG. 5 are diagrams for describing superiority of a convergence stereo method.

Since it is obvious that the parallax stereo method and the convergence stereo method are superior to the monocular method, the description of the monocular method will be omitted.

As illustrated in FIG. 5(a), in the parallax stereo method, the image capturing directions of the cameras 35a, 35b are fixed in the front direction. Therefore, an image capturing region 37a by the camera 35a and an image capturing region 37b by the camera 35b are also fixed, and their common image capturing region 37c is a region that can be surveyed.

On the other hand, in the convergence stereo method, since the image capturing directions of the right and left cameras can be freely set individually by independently rotating the cameras 36a, 36b, it is possible to stereoscopic view and survey a wide region other than the common image capturing region 37c.

For example, as illustrated in FIG. 5(b), even if the subject 33 is in a short distance in front of the camera and exists outside the image capturing region 37c, the location and the orientation can be surveyed by convergently viewing the subject 33 with the right and left virtual cameras 31, as illustrated by the arrows.

Moreover, as illustrated in FIG. 5(c), even if the subject 33 is located closer to the left side and is included in the image capturing region 37a but is not included in the image capturing region 37b, it can be surveyed by convergently viewing, as illustrated by the arrows. The same can also be applied when the subject 33 is located in the right side.

Furthermore, as illustrated in FIG. 5(d), even if the subject 33 is located further to the left side and is not included also in the image capturing region 37a, it can be surveyed by convergently viewing, as illustrated by the arrows. The same can also be applied when the subject 33 is located in the right side.

As described above, the convergence stereo method has a wider region which can be surveyed than that of the parallax stereo method, and is suitable for tracking a pedestrian, who freely moves around and frequently changes walking condition, from a short distance.

Therefore, in the present embodiment, it is configured so that the virtual cameras 31a, 31b are respectively formed in the full-spherical cameras 9a, 9b, thereby convergently viewing the subject 8.

In this way, the image capturing means included in the tracking device 1 captures the subject as an image with the convergence stereo camera which using the left camera and the right camera.

Then, an aforementioned image capturing means constitutes a left camera with a virtual camera (virtual camera 31a) that acquires the left camera image in an arbitrary direction from the left wide-angle image (left full-spherical camera image), and constitutes a right camera with a virtual camera (virtual camera 31b) that acquires the right camera image in an arbitrary direction from the right wide-angle image (right full-spherical camera image).

Furthermore, the tracking device 1 can move in the image capturing direction in a virtual image capturing space (image capturing space formed with the spherical objects 30a, 30bin which the left camera and the right camera respectively acquire the left camera image and the right camera image from the left wide-angle image and the right wide-angle image.

The tracking device 1 tracks a location where the subject 8 exists by using a particle filter, an overview of general particle filtering will now be it described.

First, in the particle filtering, a large number of particles are generated at a location where a subject to be observed object may exist.

Then, likelihood is observed for each particle by means of some method, and each particle is weighted in accordance with the observed likelihood. When observing an object on the basis of the particle, the likelihood corresponds to a probability how much the object observed on the basis of the particle is the subject to be observed.

Then, after observing the likelihood for each particle, each particle is weighted so that the larger the likelihood, the larger the weight. Consequently, since the higher the degree of existence of the subject to be observed, the greater the particle weighting, so that the distribution of weighted particles corresponds to a probability distribution representing the existence of the subject to be observed.

Furthermore, resampling is performed in order to follow time-series changes of a probability distribution due to the movement of the subject to be tracked.

In the resampling, for example, particles having small weightings are thinned out to leaves particles having large weightings, new particles are generated near the remained particles, and for each generated particle, likelihood at present is observed and weighting is performed.

Consequently, the probability distribution is updated, and a location where probability density is high, i.e., a location where there is a high possibility that the subject to be observed exists can be updated.

Hereinafter, time-series changes of the location of the subject to be observed can be tracked by repeatedly the resampling.

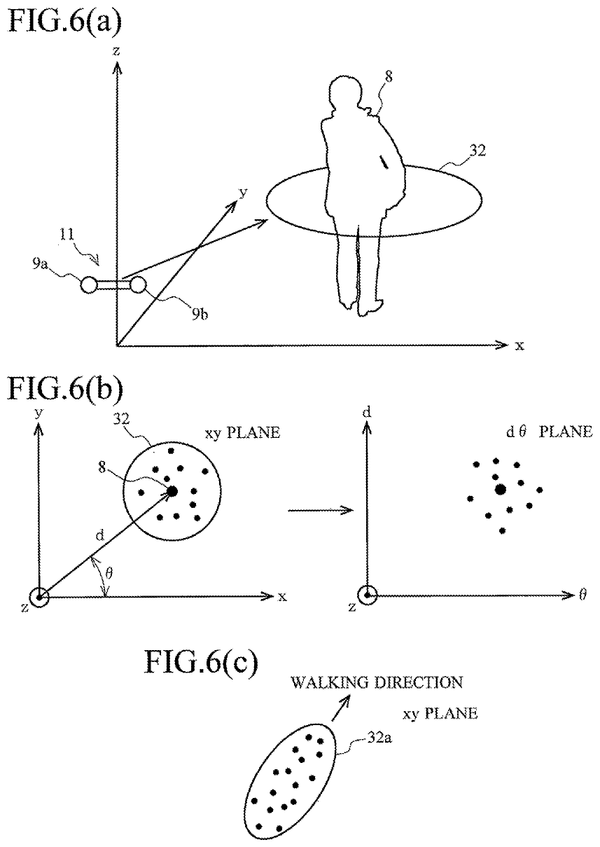

Each diagram in FIG. 6 is a diagram for describing a method of generating particles.

The tracking device 1 estimates a probability distribution of the location where the subject 8 exists by using the particle filter.

In image recognition using particle filters generally performed, particles are generated in a two dimensional camera image. In contrast, the tracking device 1 is configured to image recognize the subjects 8 including stereoscopic information by generating particles in a three dimensional space in which the subject 8 exists, and mapping and projecting these three dimensional particles on the right and left camera images.

When image recognizing without including the stereoscopic information, it is necessary to generate particles independently in the right camera image and the left camera image, and in this case, different locations may be observed with the right and left cameras, this may affect surveying accuracy and may cause false tracking.

On the other hand, since the tracking device 1 performs image recognition with the left camera image and the right camera image captured by directing the right and left cameras to the same particle in the three dimensional space, it can observe the same region with the right and left cameras, thereby effectively searching for the subject 8.

As described above, the tracking device 1 generates particles around the subject 8, but in the present embodiment, since the subject to be tracked is a pedestrian who walks in a front direction of the tracking device 1 and moves to a floor face in parallel in two dimensions, and it is set so that particles are scattered on a plane parallel to a walking surface.

If the subject to be tracked, such as a drone or a bird, moves in a height direction and moves three dimensionally, it can be tracked by scattering the particles three dimensionally.

FIG. 6(a) illustrates an aspect that a subject 8 is walking in a xyz space setting the tracking device 1 as an origin point.

The xy coordinate system is set on a plane (walking surface) on which the subject 8 walks, and the z-axis is set in the height direction. The image capturing unit 11 is located at a height (approximately 1 meter) around a torso of the subject 8.

As illustrated in the diagram, the tracking device 1 generates a noise centered on the subject 8 so that particles may be scattered approximately on the circular region 32 parallel to the xy plane in the height near the torso, thereby generating a predetermined number of the particles centered on the subject 8.

500 particles are generated in the present embodiment. According to an experiment, it can be tracked if the number of particles is equal to or greater than approximately 50.

In this embodiment, the particles are generated on the plane including the circular region 32, it can also be configured so that the particles may be distributed over a thick space extending in the height direction (z axial direction).

Since the location of the torso is a location having a high probability density where the subject 8 exists and resampling is performed in accordance with the weight (in accordance with the probability distribution) after weighting the particles, the tracking device 1 includes a particle generation means configured to generate particles used for the particle filter in three dimensional space on the basis of the probability distribution of the location where the subject exists.

Moreover, the aforementioned particle generation means generates the particles along a plane parallel to a plane where the subject moves.

Furthermore, in order to follow time-series changes of the probability distribution as the subject 8 moves by the resampling, the particle generation means sequentially generates particle this time on the basis of the previous updated probability distribution.

In this embodiment, the generated noise is a white noise (normal white noise) that follows a Gaussian distribution centered on the subject 8, and the particles can be generated around the subject 8 in accordance with the normal distribution by following the aforementioned noise. The circular region 32 illustrated in the diagram is within a range of the generated particles, e.g., approximately 3σ.

It is to be noted that other generation methods may be adopted, such as uniformly generating particles in the circular region 32.

Moreover, as described later, at the start of the tracking, the tracking device 1 surveys the location of the subject 8 by means of the normal image recognition and generates particles centered on the subject 8 on the basis thereof. However, when the location of the subject 8 is unknown, since the probability distribution where the subject 8 exists is uniform in the space, the particles may be uniformly generated in the xy plane including the circular region 32.

Since the likelihood of the particles at the location where the subject 8 exists is higher, this is resampled and thereby the probability distribution according to the location of the subject 8 can be acquired.

The tracking device 1 tracks the subject 8 by resampling the particles generated as described above.

FIG. 6(b) is a diagram schematically illustrating the circular region 32 as observed from above.

As illustrated by the black dots in the diagram, particles are generated in the circular region 32 centered on the subject 8, but since these z-coordinate values are constant, the tracking device 1 is set so that the locations of these particles and the subject 8 are expressed by a polar coordinate according to a coordinate (d, θ) for convenience. It is to be noted that the locations may be expresses by the xy coordinate.

Moreover, if a direction where the subject 8 is walking is known, the particles can also be generated so that distribution of the particles may be a circular region 32a of which a longitudinal direction is the walking direction, as illustrated in FIG. 6(c). By generating the particles along the walk direction, it is possible to suppress unnecessary calculation caused by generating the particles where a probability that the subject 8 exists is low.

Furthermore, in order to scatter particles also in a depth direction of the camera image, which is an image capturing direction, for example, when the tracking device 1 is moving through a corridor in a building, a layout of room arrangement is acquired from a top view diagram of a building interior, and it can avoid generating particles in a place having no possibility where the subjects 8 exists, such as inside walls and an off-limits room, with reference to this layout.

In this way, since the tracking device 1 generates the particles also in the depth direction of image capturing in the three dimensional space where the subject 8 moves, it is possible to generate the particles in an arbitrary distribution in consideration of a movement state of the subject to be tracked and a surrounding environment thereof.

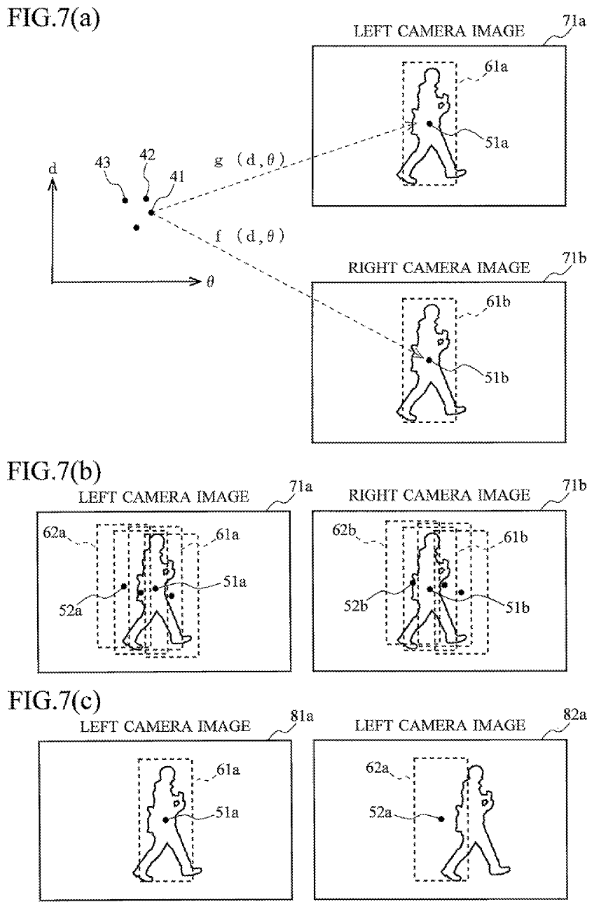

FIG. 7 are diagrams for describing mapping of particles over a camera image.

The tracking device 1 maps the particles generated as described above using functions g(d, θ) and f(d, θ) to a camera image coordinates system of a camera image 71a (left camera image) and a camera image 71b (right camera image), as illustrated in FIG. 7(a).

The camera image coordinate system is a two dimensional coordinate system, for example, having an origin point that is upper left corner of the image, the x-axis in a horizontal right direction, and the y-axis in a vertical down direction.

As described above, the tracking device 1 includes a mapping means configured to map the particles generated in a real space where the subject 8 exists to the captured image.

The mapping means then calculates and acquires locations of the generated particles in the left camera image and the right camera image by means of a predetermined mapping function.

Consequently, for example, a particle 41 scattered in space is mapped to particle 51a on the camera image 71a by means of a function g(d, θ), and is mapped to particle 51b on the camera image 71b by means of a function f(d, θ).

These mapping functions can be derived by calculating a relational expression of the convergence stereo vision and an angle in each pixel of the camera image acquired by the virtual camera 31.

As described above, the mapping means maps the particles generated in the real space to be associated with the left camera image and the right camera image captured respectively with the left camera and the right camera.

By the way, the particle 41 is accompanied with a state parameter, which is a parameter for setting a detection region in the camera image, such as a location of the detection region for performing image recognition and a size of the detection region, and the tracking device 1 sets a detection region 61a and a detection region 61b respectively in the camera image 71a and the camera image 71b on the basis thereof.

Thus, the particles 41, 42, 43, . . . are represented by a state vector having the state parameter as a component.

The detection regions 61a, 61b have a rectangular shape, and images in the detection regions 61a, 61b are partial region images to be subjected to the image recognition. The tracking device 1 performs image recognition of the subject 8 in each partial region image partitioned by the detection regions 61a, 61b.

In this embodiment, the detection regions 61a, 61b are set so that the particles 51a, 51b after mapping are the center of gravity of the rectangle. This is merely an example, and it can also be configured so that the location of the detection region 61 may be offset from the location of the particle 51 by a fixed value or function.

As described above, the tracking device 1 includes an image recognition means configured to image recognize a captured subject by setting the detection region on the basis of the locations of the mapped particles in the camera image.

Moreover, since the tracking device 1 tracks a pedestrian at a predetermined distance, the size of the detection regions 61a, 61b rarely changes significantly.

Therefore, the tracking device 1 is configured to set the size of the detection region 61 in accordance with a height of the subject 8 before the tracking and use the detection regions 61a, 61b having the fixed size.

It is to be noted that this is merely an example and the size of the detection region 61 can also be a parameter for a subject of the particle filtering.

In this case, particles are generated in state vector space of (x-coordinate value, y-coordinate value, size).

In other words, even if the xy-coordinate values are the same, particles are different from each other if the sizes thereof are different from each other, and the likelihood is observed for each. Accordingly, the likelihood of particles having a size suitable for the image recognition is increased, and thereby it can also determine the optimum size of the detection region 61.

In this way, if the particles are generated in the state vector space that defines the particle 41 without being limited to the real space, it is possible to realize a more extended operation. If there are n parameters, particles will be generated in n-dimensional space.

For example, if there are a likelihood 1 for calculating likelihood by means of a first method and a likelihood 2 for calculating likelihood by means of a second method, and it intends to combine the former at a ratio of a and the latter at a ratio of (α-1) (e.g., 0<α<1) to calculate likelihood of combining both, a state vector is set to (x-coordinate value, y-coordinate value, size, and α).

When the particle 41 is generated in such state vector space, the likelihood can be calculated also for α which is different in accordance with the particle filtering, and it can obtain (x-coordinate value, y-coordinate value, size, and α) suitable for the image recognizing the subject 8 and the likelihood in that case.

With regard to the combination of the likelihoods using α, an example of combining likelihoods according to HOG feature amount and likelihood according to the color distribution feature will be described later. The tracking device 1 generates the particles in accordance with such a procedure, and as illustrated in FIG. 7(b), maps particles 41, 42, . . . which are not illustrated to the particles 51a, 52a, . . . of the camera image 71a, and sets the detection regions 61a, 62a, . . . on the basis thereof.

Also for the camera image 71b, the particles 41, 42, . . . are mapped to the particles 51b, 52b, . . . , and the detection regions 61b, 62b, . . . are set on the basis thereof.

Then, the tracking device 1 calculates the likelihood of the particle 51a (likelihood in the left camera image of the mapped particles, and hereinafter referred to as the left likelihood) by image recognizing the subject 8 in the detection region 61a of the camera image 71a, calculates the likelihood of the particle 51b (likelihood in the right camera image of the mapped particles, and hereinafter referred to as the right likelihood) by image recognizing the subject 8 in the detection region 61b of the camera image 71b, and the likelihood of the particle 41 of a mapping source is calculated by averaging the left likelihood and the right likelihood.

The tracking device 1 similarly calculates the likelihood of each of the particles 42, 43, . . . generated in the three dimensional space.

In this way, the tracking device 1 maps the particles generated in the stereoscopic space where the subject 8 is walking to a pair of the right and left stereo camera images, and calculates the likelihood of the particles of a mapping source through the left likelihood and the right likelihood of particles mapped in the two dimensional camera image.

The tracking device 1 averaged the left likelihood and the right likelihood to be integrated and observes the likelihood of the particles of the mapping source in the three dimensional space, but this is merely an example and may be integrated by means of other calculation methods.

Moreover, such an integrated likelihood may be obtained by using at least one of the left likelihood and the right likelihood, such as using a higher likelihood as a likelihood of the mapping source among the right likelihood and the left likelihood.

As described above, the image recognition means included in the tracking device 1 recognizes images respectively in the left camera image and the right camera image.

Moreover, the tracking device 1 includes a likelihood acquisition means configured to acquire the likelihood of the particles generated on the basis of the result of image recognition. The aforementioned likelihood acquisition means acquires the likelihood by using at least one of the first likelihood (left likelihood) based on the image recognition of the left camera image and the second likelihood (right likelihood) based on the image recognition of the right camera image.

In the above example, the particles 41, 42, 43, . . . are mapped to a pair of the right and left stereo camera images by being calculated with the functions g(d, θ) and f(d, θ). However, by making full use of the virtual property of the virtual cameras 31a, 31b, and directing the virtual camera 31a and the virtual camera 31b to the generated particles 41, 42, . . . , to acquire the right and left camera images for each particle, it is also possible to map the particles 41, 42, . . . , to the center of the image for each set of the right and left camera image.

In the case of this modified example, the camera image 81a (left camera image) and the camera image 81b (right camera image) as illustrated in FIG. 7(c) are acquired by directing the image capturing directions of the virtual cameras 31a, 31b to the particle 41, and subsequently the camera image 82a (left camera image) and the camera image 82b (right camera image) are acquired by directing the image capturing directions of the virtual cameras 31a, 31b to the particle 42, and so on. Thereby, acquiring the stereo camera image of which the image capturing direction is directed to this for each particle. However, only the left camera image is illustrated in the diagram, and the right camera image is omitted.

The pinhole camera that constitutes the virtual camera 31 has a single focus, and even if the particles 41, 42, . . . are captured in a spherical object 30 with the virtual camera 31 directed to the forementioned particles, the image of the subject 8 can be obtained in a state of being in focus.

Moreover, since the virtual camera 31 is formed with software, a mechanical drive thereof is unnecessary, and the particles 41, 42, . . . can be captured by switching the image capturing direction at high speed.

Alternatively, it can also be configured so that a plurality of virtual cameras 31, 31, . . . are set up and are driven in parallel to acquire a plurality of stereo camera images at once.

As illustrated in FIG. 7(c), when the virtual camera 31a is directed to particle 41 to capture it, a camera image 81a in which the particle 41 is mapped to the particle 51a at the center of the image can be obtained.

Although not illustrated, when the virtual camera 31b is directed to the particle 41 to capture it, the camera image 81b in which the particle 41 is mapped to the particle 51b at the center of the image can be similarly obtained.

The tracking device 1 image recognizes the camera images 81a, 81b and obtains the left likelihood and the right likelihood due to the particles 51a, 51b, which are averaged to obtain the likelihood of the particles 41.

Hereinafter, similarly, the virtual cameras 31a, 31b are directed to the particle 42 and captures it, the camera images 82a, 82b are acquired (the camera image 82b is not illustrated), and thereby the likelihood of the particle 42 is calculated on the basis of the left likelihood and the right likelihood of the particles 52a, 52b mapped to the center of the image.

The tracking device 1 repeats this processing to calculate the likelihoods of the particles 41, 42, 43, . . . .

In this way, the image capturing means in this example directs and captures the left camera and the right camera for each generated particle, and the mapping means acquires the locations (e.g., the center of the image) corresponding to the image capturing directions of the left camera image and the right camera image as a location of the particle.

In the above, the two methods of mapping the particles generated in the three dimensional space where the subject 8 walks to the right and left camera images have been described, but in the following, the case of mapping by means of the former method will be described. The latter method may be used to map the image.

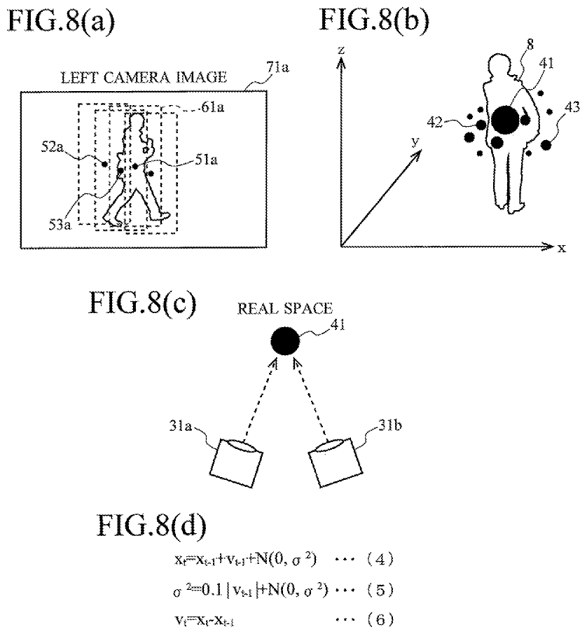

Each diagram in FIG. 8 is a diagram for describing a method of tracking a location of the subject 8 with the virtual camera 31.

As described above, the tracking device 1 performs image recognition, in the camera image 71a, by using the detection region 61a, as illustrated in FIG. 8(a), and thereby calculates the left likelihood of the particle 51a. Then, in the camera image 71b not illustrated, the image recognition by using the detection region 61b is performed, and thereby the right likelihood of the particle 51b is calculated.

Furthermore, the tracking device 1 calculates the likelihood of particle 41, which is a mapping source of the particles 51a, 51b, by averaging the left likelihood and the right likelihood.

The tracking device 1 repeats this calculation and calculates the likelihood of the particles 42, 43, . . . which are three dimensionally scattered around the subject 8.

Then, the tracking device 1 weights each particle generated in the three dimensional space in accordance with the calculated likelihood so that the greater the likelihood, the greater the weight.

FIG. 8(b) illustrates particles 41, 42, 43, . . . after weighting, where the larger the weighting, the larger the size of the black dots.

In the example in the diagram, the weight of the particle 41 is the largest and the weight of the particles around it are also large.

In this way, distribution of the particles weighted in the real space is acquired, this distribution of to weights corresponds to a probability distribution of the location where the subject 8 exists. Accordingly, in the example in diagram, it can be estimated that the subject 8 exists in a vicinity of the particle 41.

Various estimation methods are possible, such as estimating that the subject to be tracked exists in a location of a peak of the weights, or estimating that the subject to be tracked exists within a range of the top 5% of the weights.

The location where the subject 8 exists can be tracked by updating such a probability distribution by resampling.

Thus, the tracking device 1 includes a tracking means configured to track a location where the subject exists by updating the probability distribution on the basis of the acquired likelihood.

Moreover, the tracking device 1 can direct the image capturing direction of the virtual cameras 31a, 31b to the subject 8 by directing the virtual cameras 31a, 31b to a location of a large probability distribution (i.e., to a location having a high possibility where the subject 8 exists).

In the example illustrated in FIG. 8(c), the virtual cameras 31a, 31b are directed to particles 41 having the largest likelihood.

As described above, the tracking device 1 includes the image capturing direction traveling means configured to move the image capturing direction of the left camera and the right camera in the direction of the subject on the basis of the updated probability distribution.

In this embodiment, although the virtual camera 31 is directed to the particles having the largest likelihood, this is merely an example, and the virtual camera 31 may be directed to a location having a high probability distribution in accordance with some algorithm.

In this way, the subject 8 can be caught at the front of the cameras by directing the virtual cameras 31a, 31b to the location having a high probability density.

Furthermore, since the location (d, θ) of the subject 8 can be surveyed from an angle at which the virtual cameras 31a, 31b convergently view, a command can be issued to the control unit 6 on the basis of an output value of the location (d, θ) to control the tracking device 1 to move to a predetermined position behind the subject 8.

In this way, the tracking device 1 includes a surveying means configured to survey a location where the subject exists on the basis of the image capturing direction of the left camera and the right camera moving on the basis of the probability distribution, and an output means configured to output a survey result of being surveyed. The tracking device 1 further includes a moving means configured to drive the drive device 7 on the basis of the outputted survey result and to move with the subject.

By the way, although the resampling is performed so that the probability distribution is updated in accordance with the movement of the subject 8 after performing the weighting of the particles, as shown in FIG. 8(b), this is performed by generating (or more generating) the next particle in the vicinity of the particle having a high likelihood, such as the particle 41, in accordance with white noise, and not generating (or generating few) the next particle in the vicinity of the particle having a low likelihood, and calculating and weighting the likelihood using new left and right camera images for the new particles generated in this way.

In this way, it is possible to sequentially track a location having a high probability of the subject 8 existing by sequentially repeating the process of resampling the particles having high likelihood and reducing the particles having low likelihood to update the probability distribution.

As an example, in the present embodiment, a state is made to transit (particles for resampling are generated) on the basis of the equation (4) shown in FIG. 8(d) in consideration of velocity information of the subject 8.

In this case, xt denotes the location of the particles at time t, and xt-1 denotes the location of the particles at time t-1.

vt-1 is the velocity information of the subject 8, which is subtracted the location at time t-1 from the location at time t as expressed in the equation (6).

N(0, σ2) is a term of noise and represents the normal distribution of variance σ2 in the location of particles.

As expressed by the equation (5), σ2 is set so that the amount of movement of the subject 8 increases as the velocity increases, and therefore the variance increases accordingly.

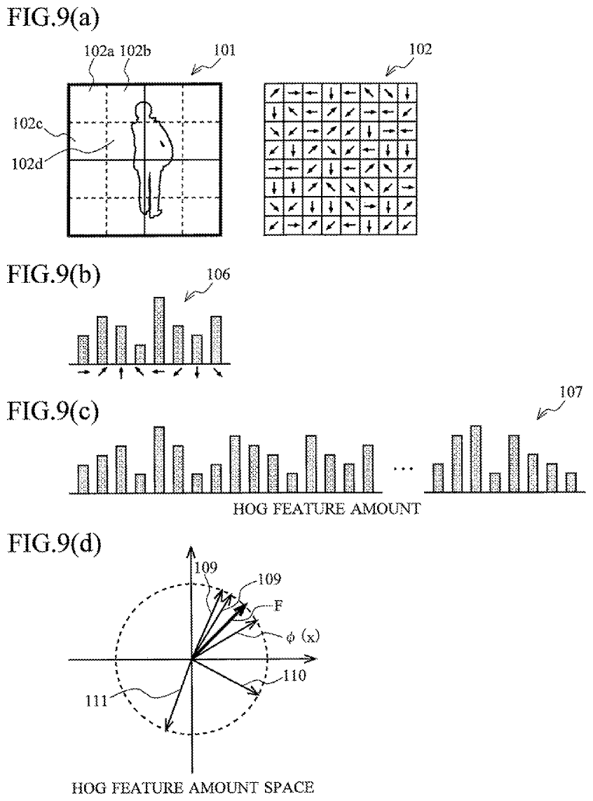

FIG. 9 are diagrams for describing a method of calculating a likelihood.

Although any method can be used to calculate the likelihood, an example using HOG feature amount will now be described herein as an example. This calculation method can be used to calculate the right likelihood and the left likelihood.

The HOG feature amount is an image feature amount using a luminance gradient distribution, and it is a technology to detect edges of a target. For example, it recognizes the target from a silhouette formed of the edges.

The HOG feature amount is extracted from an image by the following procedure.

An image 101 illustrated in left diagram of FIG. 9(a) illustrates an image extracted from a camera image by using a detection region.

First, the image 101 is divided into rectangular cells 102a, 102b, . . . .

Then, as illustrated in a right diagram of FIG. 9(a), luminance gradient directions (directions from a low luminance toward a high luminance) of respective pixels are quantized into, e.g., eight directions in accordance with each cell 102.

Subsequently, as illustrated in FIG. 9(b), the quantized directions of the luminance gradients are determined as classes, and a histogram showing the number of occurrences as a frequency is produced, whereby the histogram 106 of the luminance gradients included in the cell 102 is produced in accordance with each cell 102.

Further, normalization is performed in such a manner that a total frequency of the histograms 106 becomes 1 in blocks each forming a group of several cells 102.

In the example illustrated in the left diagram of FIG. 9(a), the cells 102a, 102b, 102c, and 102d form one block.

A histogram 107 in which the histograms 106a, 106b, . . . normalized in this manner (not illustrated) are arranged in a line as illustrated in FIG. 9(c) becomes an HOG feature amount of the image 101.

A similarity degree of each image using the HOG feature amount is determined as follows.

First, a consideration is given to a vector φ(x) having a frequency (which is assumed to be M) of the HOG feature amount as a component. Here, x is a vector which represents the image 101, and x=(a luminance of a first pixel, a luminance of a second pixel, . . . ) is achieved.

It is to be noted that the vector is written by using a bold type, but it is written in a normal letter in the following description to avoid erroneous conversion of character codes.

FIG. 9(d) shows an HOG feature amount space, and the HOG feature amount of the image 101 is mapped to vectors φ(x) in an M-dimensional space.

It is to be noted that the drawing shows the HOG feature amount space as a two dimensional space for simplification.

On the other hand, F is a weight vector obtained by learning person images, and it is a vector provided by averaging HOG feature amounts of many person images.

Each φ(x) is distributed around F like vectors 109 when the image 101 is similar to learned images, and if not similar thereto, it is distributed in a direction different from that of F like vectors 110 and 111.

F and φ(x) are standardized, and a correlation coefficient defined by an inner product of F and φ(x) approximates 1 as the image 101 becomes more similar to the learned images, and it approximates −1 as a similarity degree lowers.

In this manner, when the image which is a target of similarity determination is mapped to the HOG feature amount space, each image which is similar to the learned images and each image which is dissimilar to the same can be separated from each other by using the luminance gradient distribution.

This correlation coefficient can be used as the likelihood.

In addition thereto, the likelihood can also be evaluated by using color distribution features.

For example, an image 101 is composed of pixels having various color components (color 1, color 2, . . . ).

When a histogram is produced from appearance frequencies of these color components, a vector q having this frequency as a component is provided.

On the other hand, a similar histogram is produced for a tracking target model prepared in advance using the subject 8, and a vector p having this frequency as a component is provided.

If an image of the image 101 is similar to the tracking target model, q is distributed around p, and if not similar thereto, q is distributed in a direction different from that of p.

q and p are standardized, and a correlation coefficient defined by an inner product of q and p approximates 1 as the image 101 becomes more similar to the tracking target model, and it approximates −1 as a similarity degree lowers.

In this manner, when the image which is a target of similarity determination is mapped to the color feature amount space, each image which is similar to the tracking target model and each image which is dissimilar to the same can be separated from each other by using the color feature amount distribution.

This correlation coefficient can also be used as the likelihood.

It is also possible to, for example, combine the similarity by the HOG feature amount and the similarity by the color distribution feature.

The HOG feature amount and the color distribution feature have a scene good at recognition, and a scene poor at recognition, and it can improve the robustness of the image recognition by combining both.

In this case, the parameter a previously described is used (set to 0.25<α<0.75 in accordance with an experiment), the likelihood is defined in accordance with the equation α×(similarity by the HOG feature amount)+(1−α)×(similarity by the color distribution feature), and the particles are generated in the state vector space including α, thereby obtaining also α for maximizing the likelihood.

According to this equation, a contribution of the HOG feature amount increases as a becomes large, and a contribution of the color distribution feature amount increases as a becomes small.

Thus, appropriately selecting a enables acquiring a value suitable for each scene and improving robustness.

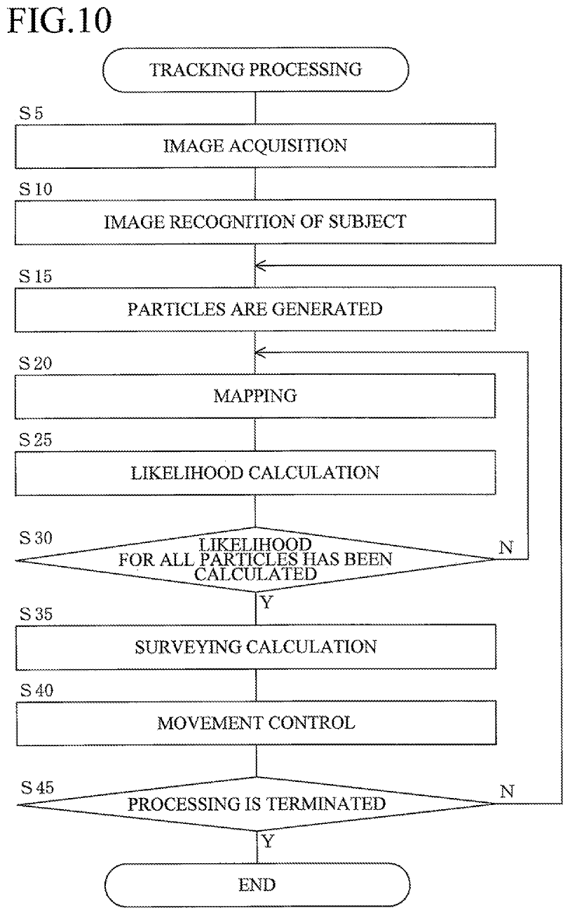

FIG. 10 is a flow chart for describing tracking processing performed by the tracking device 1.

The following processing is performed by the CPU 2 in accordance with a tracking program stored in the storage unit 10.

First, the CPU 2 asks a user to input a height of the subject 8, etc., sets a size of the right and left detection region on the basis thereof, and stores this information in the RAM 4.

Next, the subject 8 is asked to stand in a predetermined position in front of the tracking device 1, and the CPU 2 captures the subject with the virtual cameras 31a, 31b, acquires the left camera image and the right camera image, and store the acquired images in the RAM 4 (Step 5).

In for more details, the CPU 2 stores in the RAM 4 a left full-spherical camera image and a right full-spherical camera image respectively captured by the full-spherical cameras 9a, 9b, and respectively pastes them on the spherical objects 30a, 30b by calculation.

Then, the left camera image and the right camera image obtained by capturing them with the virtual cameras 31a, 31b from inside respectively are acquired by calculation to be stored in the RAM 4.

Next, the CPU 2 image recognizes the subject 8 by using the right and left camera images (Step 10).

A method currently generally performed is used for this image recognition, for example, such as, scanning the detection region of the size stored in the RAM 4 respectively with the right and left camera images to search for the subject 8.

Then, the CPU 2 directs the respective virtual cameras 31a, 31b in the direction of the subject 8 image recognized.

Next, the CPU 2 surveys a location of the subject 8 from an angle of each of the virtual cameras 31a, 31b and thereby acquires the location where the subject 8 exists as the distance d and the angle θ to the subject 8 to be stores in the RAM 4.

Then, the CPU 2 calculates a location and a direction of the subject 8 with respect to the tracking robot 12 on the basis of the acquired location (d, θ) of the subject 8 and angles between the front direction of the tracking robot 12 and the virtual cameras 31a, 31b, and issues a command to the control unit 6 to move the tracking robot 12 so that the subject 8 may be located at a predetermined position in front of the tracking robot 12. At this time, the CPU 2 adjusts the angles of the virtual cameras 31a, 31b so as to capture the subject 8 in front of the cameras.

Next, the CPU 2 generates a white noise on a horizontal plane at a predetermined height (around the torso) of a location where the subject 8 exists, and generates a predetermined number of particles in accordance therewith (Step 15). Then, the CPU 2 stores the location (d, θ) of each particle in the RAM 4.

Although the processing for each particle in the following Steps 20 and 25 is processed in parallel by the GPU 5, it is assumed that the CPU 2 performs the processing in this case, for the sake of simplification of the explanation.

Next, the CPU 2 selects one of the generated particles and maps the selected particle respectively by means of the functions g(d, θ) and f(d, θ) to the left camera image and the right camera image, and stores image coordinate values of these mapped particles in the RAM 4 (Step 20).

Next, for each of the left camera image and the right camera image, the CPU 2 calculates a left camera image likelihood and a right camera image likelihood based on the mapped particles, and calculates, by averaging both, a likelihood of the particles of the mapping source to be stored in the RAM 4 (Step 25).

Next, the CPU 2 determines whether or not the likelihood has been calculated for all generated particles of the mapping source (Step 30).

If there are particles that have not yet been calculated (Step 30; N), it returns to Step 20 to calculate the likelihood of the next particle.

On the other hand, if the likelihood for all particles has been already calculated (Step 30; Y), the CPU 2 weights each particle on the basis of the likelihood of particles and stores the weight for each particle in the RAM 4.

Next, the CPU 2 estimates the location of the subject 8 with respect to the image capturing unit 11 on the basis of distribution of the weights of particles, and directs the virtual cameras 31a, 31b to the estimated location of the subject 8.

Then, the CPU 2 surveys and calculates the location of the subject 8 on the basis of the angles of the virtual cameras 31a, 31b, and stores the calculated coordinate (d, θ) of the subject 8 in the RAM 4 (Step 35).

Furthermore, the CPU 2 calculates a coordinate of the location of the subject 8 with respect to the tracking robot 12 on the basis of the coordinate (d, θ) of the subject 8 stored in the RAM 4 in Step 35 and the angles formed by the front direction of the tracking robot 12 and the image capturing directions of the virtual cameras 31a, 31b, and uses this to control the movement by issuing a command to the control unit 6 so that the tracking robot 12 moves to a predetermined tracking location behind the subject 8 (Step 40).

In response thereto, the control unit 6 drives the drive device 7 to move the tracking robot 12 so as to follow the subject 8 from the behind of the subject 8.

Next, the CPU 2 determines whether or not the tracking processing is terminated (Step 45). If it is determined that the processing is continued (Step 45; N), the CPU 2 returns to Step 15 to generate the next particles. If it is determined that the processing is terminated (Step 45; Y), the processing is terminated.

This determination is made, for example, when the subject 8 has reached at a destination, by having the subject utter something such as “I have arrived,” which is then recognized by voice recognition, or by having the subject make a specific gesture.

As mentioned above, although the tracking device 1 of the present embodiment has been described, various modification can be made.

For example, the tracking robot 12 can also be remotely controlled by mounting the image capturing unit 11, the control unit 6, and the drive device 7 in the tracking robot 12, and providing other components in the tracking device 1 in a server, and connecting the server to the tracking robot 12 with a communication line.

Moreover, it can also be configured so that, in addition to the virtual cameras 31a, 31b the image capturing unit 11 can be provided with a virtual camera for external observation and an image captured with the aforementioned camera is transmitted to the server.

Furthermore, the tracking device 1 can be provided with a microphone and a loudspeaker so that a third party can interact with the subject to be tracked while observing the image of the virtual camera for external observation through a mobile terminal or the like.

In this case, for example, an elderly person can be accompanied by the tracking robot 12 on a walk, and a caregiver can observe the surroundings of the tracking robot 12 from a mobile terminal and say to the elderly person, “Please be careful, there is a car coming.”

### Second Embodiment

Although the full-spherical cameras 9a, 9b are arranged in the right and left direction in the image capturing unit 11 included in the tracking device 1 of the first embodiment, such cameras are arranged in a vertical direction in an image capturing unit 11b included in a tracking device 1b of a second embodiment.

Although not illustrated in the diagrams, the configuration of the tracking device 1b is similar to that of the tracking device 1 illustrated in FIG. 2, except that the full-spherical cameras 9a, 9b are arranged in the vertical direction.

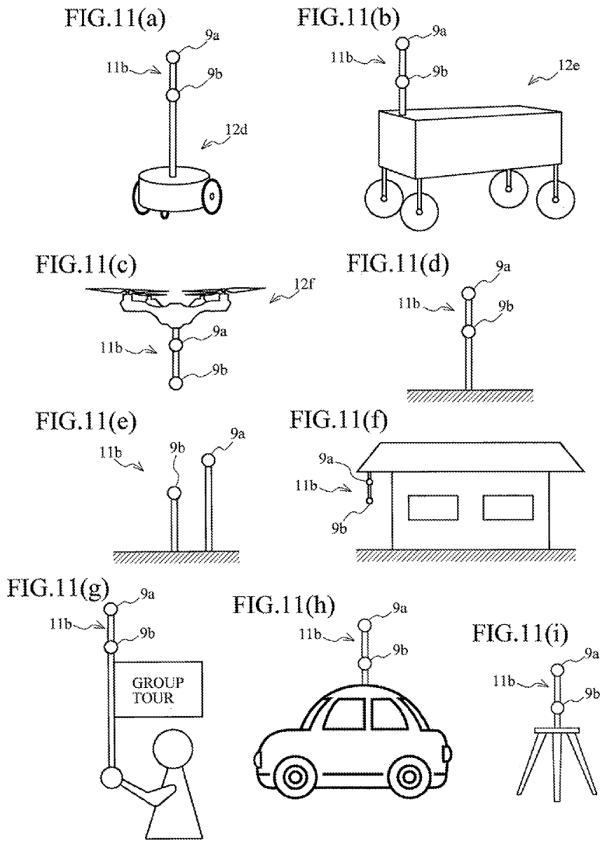

Each diagram in FIG. 11 is a diagram illustrating an example of an appearance of a tracking robot 12 according to the second embodiment.

A tracking robot 12d illustrated in FIG. 11(a) corresponds to a tracking robot 12a (FIG. 1(a)), in which the full-spherical cameras 9a, 9b are installed in the vertical direction.

The image capturing unit 11b is disposed at a tip of a columnar member, the full-spherical camera 9a is arranged at an upper side in the vertical direction, and the full-spherical camera 9b is arranged at a lower side in the vertical direction.

In this way, the longitudinal direction of the image capturing unit 11 is installed to be the horizontal direction in the first embodiment, but the longitudinal direction of the image capturing unit 11b is installed to be the vertical direction in the second embodiment.

It is also possible to arrange the full-spherical camera 9a may be located in a diagonally upward direction of the full-spherical camera 9b, and in this case, the full-spherical camera 9a may be located at the upper side of a certain horizontal plane and the full-spherical camera 9b may be located at a lower side of the horizontal plane.

As described above, the tracking device 1b includes an image capturing means configured to capture a subject with a convergence stereo camera using an upper camera arranged at an upper side of a predetermined horizontal plane and a lower camera arranged at a lower side thereof.

Since the full-spherical cameras 9a, 9b are installed in the horizontal direction (lateral direction) in the case of the image capturing unit 11, the aforementioned lateral direction is a blind spot. However, in the image capturing unit 11b, since the full-spherical cameras 9a, 9b are installed in the vertical direction (lengthwise direction), there is no blind spot over the entire 360 degree circumference, and even if the subject 8 exists in any around location of the tracking robot 12, the image of the subject 8 can be acquire.

The tracking robots 12e and 12f illustrated in FIG. 11(b) and FIG. 11(c) respectively correspond to the tracking robots 12b and 12c illustrated in FIG. 1(b) and FIG. 1(c), and the respective full-spherical cameras 9a, 9b are arranged in the vertical direction in the image capturing unit 11b.

FIG. 11(d) illustrates an example where a pillar is set up on a road surface and the image capturing unit 11b attached at a tip thereof. A passing person who walks on the road can be tracked.

FIG. 11(e) illustrates an example where two pillars having difference heights are set up on a road surface, and the image capturing unit 11b is configured so that the full-spherical camera 9b is attached at a tip of the lower pillar and the full-spherical camera 9a is attached at a tip of the higher pillar.

In this way, the full-spherical cameras 9a, 9b may be respectively attached on different support members, or may further be installed in a diagonally vertical direction.

FIG. 11(f) illustrates an example where the image capturing unit 11b is installed in a form of a suspension under the eaves of buildings, such as a house or building.

FIG. 11(g) illustrates an example where the image capturing unit 11b is provided at a tip of a flag held by a tour conductor of group tour. Each tourist's location can be tracked by face recognition of face of each group tourists.

FIG. 11(h) illustrates an example of installing the image capturing unit 11b on a roof of a vehicle. A location of surrounding environmental object, such as a location of a front vehicle, can be acquired.

FIG. 11(i) illustrates an example of installing the image capturing unit 11b on a tripod mount. This can be used in a civil engineering field, for example.

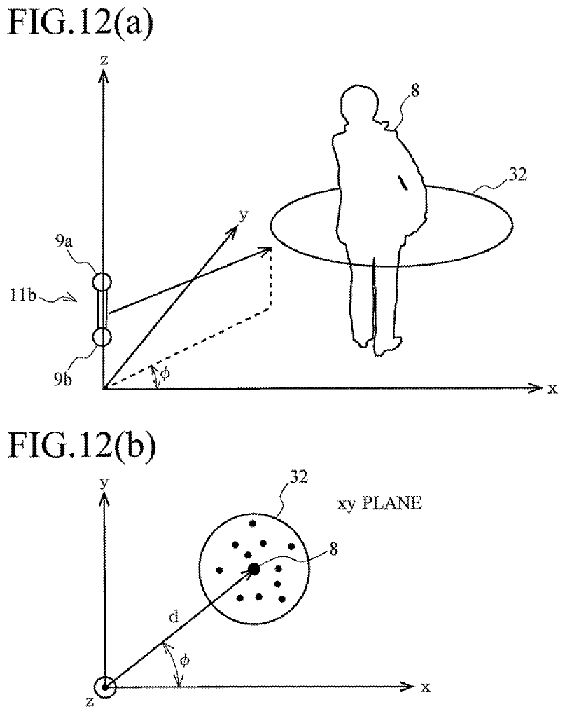

FIG. 12 are diagrams for describing a survey method used in the second embodiment.

The generation method of the particles is the same as that of the first embodiment.

As illustrated in FIG. 12(a), the tracking device lb is configured to convergently view by using virtual cameras 31a, 31b, which are not illustrated, installed in the full-spherical cameras 9a, 9b in a plane including the z-axis and the subject 8, and to rotate them around the z-axis (rotation angle is φ) and direct the image capturing direction toward the subject 8.

As illustrated in FIG. 12(b), the tracking device lb can survey a location of the subject 8 by using a coordinate (d, φ) based on a distance d of the subject 8 and a rotation angle φ around of the z-axis of the virtual cameras 31a, 31b.

Regarding each means included in the tracking device 1b other than the image capturing means, the particle generation means configured to generate the particles, the tracking means configured to track the location where the subject exists, the output means configured to output a survey result, and the moving means configured to move on the basis of the survey result are the same as those in the tracking device 1.

Moreover, regarding the mapping means configured to map the particles, the image recognition means configured to perform image recognition, the likelihood acquisition means configured to acquire the likelihood of particles, the image capturing direction moving means configured to move in the image capturing direction, the surveying means configured to survey the location where the subject exists, and the wide-angle image acquisition means configured to acquire the wide-angle image, each included in the tracking device 1b; left and right elements can be configured to be respectively to upper and lower elements as follows: the left camera, the right camera, the left camera image, the right camera image, the left wide-angle camera, the right wide-angle camera, the left wide-angle image, the right wide-angle image, the left full-spherical camera, and the right full-spherical camera correspond to respectively an upper camera, a lower camera, an upper camera image, a lower camera image, an upper wide-angle camera, a lower wide-angle camera, an upper wide-angle image, a lower wide-angle image, an upper full-spherical camera, and a lower full-spherical camera.

As described above, the first and second embodiments can thus be configured as follows.

### (1) Configuration of First Embodiment

### (101st Configuration)

A tracking device including: a particle generation means configured to generate particles used for a particle filter in three dimensional space on the basis of a probability distribution of a location where a subject exists; an image capturing means configured to capture the subject as an image; a mapping means configured to map the generated particles to the captured image; an image recognition means configured to set a detection region on the basis of a location in the image of the mapped particles, and to image recognize the captured subject; a likelihood acquisition means configured to acquire a likelihood of the generated particles on the basis of a result of the image recognition; and a tracking means configured to track a location where the subject exists by updating the probability distribution on the basis of the acquired likelihood, wherein the particle generation means sequentially generates the particles on the basis of the updated probability distribution.

### (102nd Configuration)

The tracking device according to 101st configuration, wherein the particle generation means generates the particles along a plane parallel to a plane where the subject moves.

(103rd configuration)

The tracking device according to 101st configuration or 102nd configuration, wherein: the image capturing means captures the subject with a convergence stereo camera using a left camera and a right camera; the mapping means maps the generated particles to be associated with a left camera image and a right camera image captured respectively with the left camera and the right camera; the image recognition means performs image recognition by using each of the left camera image and the right camera image; the likelihood acquisition means acquires the likelihood by using at least one of a first likelihood based on the image recognition of the left camera image and a second likelihood based on the image recognition of the right camera image; and the tracking device further includes an image capturing direction moving means configured to move image capturing directions of the left camera and the right camera in a direction of the subject on the basis of the updated probability distribution.

### (104th Configuration)

The tracking device according to 103rd configuration, further including: a surveying means configured to survey the location where the subject exists on the basis of the moved image capturing directions of the left camera and the right camera; and an output means configured to output a survey result of the surveying.

### (105th Configuration)

The tracking device according to 104th configuration, further including a wide-angle image acquisition means configured to respectively acquire a left wide-angle image and a right wide-angle image from a left wide-angle camera and a right wide-angle camera, wherein: the image capturing means constitutes the left camera with a virtual camera configured to acquire a left camera image in an arbitrary direction from the acquired left wide-angle image, and the right camera with a virtual camera configured to acquire a right camera image in an arbitrary direction from the acquired right wide-angle image; and the image capturing direction moving means moves the image capturing direction in a virtual image capturing space where the left wide-angle camera and the right wide-angle camera respectively acquire the left camera image and the right camera image respectively from the left wide-angle image and the right wide-angle image.

### (106th Configuration)

The tracking device according to 105th configuration, wherein the left wide-angle camera and the right wide-angle camera are respectively a left full-spherical camera and a right full-spherical camera.

### (107th Configuration)

The tracking device according to any one of 103rd configuration to 106th configuration, wherein the mapping means calculates and acquires a location in the left camera image and the right camera image of the generated particles by means of a predetermined mapping function.

### (108th Configuration)

The tracking device according to any one of 103rd configuration to 106th configuration, wherein: the image capturing means directs the left camera and the right camera to each generated particle, and captures each generated particle; and the mapping means acquires a location corresponding to the image capturing directions of the left camera image and the right camera image as a location of the particles.

### (109th Configuration)

The tracking device according to 104th configuration, further including a moving means configured to move with the subject on the basis of the survey result which is output.

### (110th Configuration)

A tracking program implementing functions by using a computer, the functions including: a particle generation function configured to generate particles used for a particle filter in three dimensional space on the basis of a probability distribution of a location where a subject exists; an image capturing function configured to capture the subject as an image; a mapping function configured to map the generated particles to the captured image; an image recognition function configured to set a detection region on the basis of a location in the image of the mapped particles, and to image recognize the captured subject; a likelihood acquisition function configured to acquire a likelihood of the generated particles on the basis of a result of the image recognition; and a tracking function configured to track a location where the subject exists by updating the probability distribution on the basis of the acquired likelihood, wherein the particle generation function sequentially generates the particles on the basis of the updated probability distribution.

### (2) Configuration of Second Embodiment

### (201st Configuration)

A detection device installed in a traveling body, a building structure, or the like, the detection device configured to detect a predetermined subject, the detection device comprising: an image capturing means configured to captures the subject at a wide angle with an upper camera arranged at an upper side of a predetermined horizontal plane and a lower camera arranged at a lower side of the horizontal plane; and a detection means configured to detect the captured subject by performing image recognition by using each of an upper camera image of the upper camera and a lower camera image of the lower camera.

### (202nd Configuration)

A tracking device comprising a particle generation means configured to generate particles used for a particle filter in three dimensional space on the basis of a probability distribution of a location where a subject exists, a detection device according to claim 1, a likelihood acquisition means, and a tracking means, wherein the image capturing means in the detection device captures the subject with a convergence stereo camera using the upper camera arranged at the upper side of the predetermined horizontal plane and the lower camera arranged at the lower side thereof, wherein the detection means in the detection device comprises a mapping means configured to map the generated particles to be associated with the upper camera image and the lower camera image captured respectively with the upper camera and the lower camera and an image recognition means configured to set a detection region to each of the upper camera image and the lower camera image on the basis of each location in the upper camera image and the lower camera image of the mapped particles, and perform image recognition of the captured subject by using each of the upper camera image and the lower camera image, wherein the likelihood acquisition means acquires a likelihood of the generated particles by using at least one of a first likelihood based on the image recognition of the upper camera image and a second likelihood based on the image recognition of the lower camera image; the tracking means tracks a location where the subject exists by updating the probability distribution on the basis of the acquired likelihood; and the particle generation means sequentially generates the particles on the basis of the updated probability distribution.

### (203rd Configuration)

The tracking device according to claim 2, wherein the particle generation means generates the particles along a plane parallel to a plane where the subject moves.

### (204th Configuration)

The tracking device according to claim 2 or claim 3, further comprising: an image capturing direction moving means configured to move image capturing directions of the upper camera and the lower camera in a direction of the subject on the basis of the updated probability distribution.

### (205th Configuration)

The tracking device according to claim 4, further comprising: a surveying means configured to survey the location where the subject exists on the basis of the moved image capturing directions of the upper camera and the lower camera; and an output means configured to output a survey result of the surveying.

(206th configuration)

The tracking device according to any one of claims 2 to 5, further comprising: a wide-angle image acquisition means configured to acquire an upper wide-angle image and a lower wide-angle image respectively from an upper wide-angle camera arranged at an upper side of a predetermined horizontal plane and a lower wide-angle camera arranged at a lower side thereof, wherein the image capturing means constitutes the upper camera with a virtual camera configured to acquire an upper camera image in an arbitrary direction from the acquired upper wide-angle image, and the lower camera with a virtual camera configured to acquire a lower camera image in an arbitrary direction from the acquired lower wide-angle image; and the image capturing direction moving means moves the image capturing direction in a virtual image capturing space where the upper camera and the lower camera respectively acquire the upper camera image and the lower camera image respectively from the upper wide-angle image and the lower wide-angle image.

(207th Configuration)

The tracking device according to claim 6, wherein the upper wide-angle camera and the lower wide-angle camera are respectively an upper full-spherical camera and a lower full-spherical camera.

(208th Configuration)

The tracking device according to any one of claims 2 to 7, wherein the mapping means calculates and acquires a location in the upper camera image and the lower camera image of the generated particles by means of a predetermined mapping function.

### (209th Configuration)

The tracking device according to any one of claims 2 to 7, wherein the image capturing means directs the upper camera and the lower camera to each generated particle, and captures each generated particle; and the mapping means acquires a location corresponding to the image capturing directions of the upper camera image and the lower camera image as a location of the particles.

### (210th Configuration)

The tracking device according to any one of claims 2 to 9, further comprising: a moving means configured to move with the subject on the basis of the survey result which is output.

### (211th Configuration)

The tracking device according to any one of claims 2 to 10, wherein the upper camera and the lower camera are arranged on a vertical line.

### (212th Configuration)

A detection program functioning a computer as a detection device installed in a traveling body, a building structure, or the like, the detection device configured to detect a predetermined subject, the detection program comprising: an image capturing function configured to captures the subject at a wide angle with an upper camera arranged at an upper side of a predetermined horizontal plane and a lower camera arranged at a lower side of the horizontal plane; and a detection function configured to detect the captured subject by performing image recognition by using each of an upper camera image of the upper camera and a lower camera image of the lower camera.

### (213th Configuration)

A tracking program implementing functions by using a computer, the functions including: a particle generation function configured to generate particles used for a particle filter in three dimensional space on the basis of a probability distribution of a location where a subject exists; an image capturing function configured to capture the subject with a convergence stereo camera using an upper camera arranged at an upper side of the predetermined horizontal plane and a lower camera arranged at a lower side thereof; a mapping function configured to map the generated particles to be associated with an upper camera image and a lower camera image captured respectively with the upper camera and the lower camera; an image recognition function configured to set a detection region to each of the upper camera image and the lower camera image on the basis of each location in the upper camera image and the lower camera image of the mapped particles, and perform image recognition of the captured subject by using each of the upper camera image and the lower camera image; a likelihood acquisition function configured to acquire a likelihood of the generated particles by using at least one of a first likelihood based on the image recognition of the upper camera image and a second likelihood based on the image recognition of the lower camera image; and a tracking function configured to track a location where the subject exists by updating the probability distribution on the basis of the acquired likelihood, wherein the particle generation function sequentially generates the particles on the basis of the updated probability distribution.

### REFERENCE SIGNS LIST

1 Tracking device
2 CPU
3 ROM
4 RAM
5 GPU
6 Control unit
7 Drive device
8 Subject
9 Full-spherical camera
10 Storage unit
11 Image capturing unit
12 Tracking robot
15 Housing
16 Rear wheel
17 Front wheel
20 Housing
21 Rear wheel
22 Front wheel
25 Housing
26 Propeller
30 Spherical object
31 Virtual camera
32 Circular region
33 Subject
35, 36 Camera
37 Image capturing region
41, 42, 43 Particle
51, 52 Particle
61, 62 Detection region
71, 81, 82 Camera image
101 Image
102 Cell
106, 107 Histogram
109, 110, 111 Vector

1. A detection device installed in a traveling body, a building structure, or the like, the detection device configured to detect a predetermined subject, the detection device comprising:
an image capturing means configured to captures the subject at a wide angle with an upper camera arranged at an upper side of a predetermined horizontal plane and a lower camera arranged at a lower side of the horizontal plane; and
a detection means configured to detect the captured subject by performing image recognition by using each of an upper camera image of the upper camera and a lower camera image of the lower camera.

2. A tracking device comprising a particle generation means configured to generate particles used for a particle filter in three dimensional space on the basis of a probability distribution of a location where a subject exists, a detection device according to claim 1, a likelihood acquisition means, and a tracking means,
wherein the image capturing means in the detection device captures the subject with a convergence stereo camera using the upper camera arranged at the upper side of the predetermined horizontal plane and the lower camera arranged at the lower side thereof,
wherein the detection means in the detection device comprises a mapping means configured to map the generated particles to be associated with the upper camera image and the lower camera image captured respectively with the upper camera and the lower camera and an image recognition means configured to set a detection region to each of the upper camera image and the lower camera image on the basis of each location in the upper camera image and the lower camera image of the mapped particles, and perform image recognition of the captured subject by using each of the upper camera image and the lower camera image,
wherein the likelihood acquisition means acquires a likelihood of the generated particles by using at least one of a first likelihood based on the image recognition of the upper camera image and a second likelihood based on the image recognition of the lower camera image;
the tracking means tracks a location where the subject exists by updating the probability distribution on the basis of the acquired likelihood; and
the particle generation means sequentially generates the particles on the basis of the updated probability distribution.

3. The tracking device according to claim 2,
wherein the particle generation means generates the particles along a plane parallel to a plane where the subject moves.

4. The tracking device according to claim 2, further comprising:
an image capturing direction moving means configured to move image capturing directions of the upper camera and the lower camera in a direction of the subject on the basis of the updated probability distribution.

5. The tracking device according to claim 4, further comprising:
a surveying means configured to survey the location where the subject exists on the basis of the moved image capturing directions of the upper camera and the lower camera; and
an output means configured to output a survey result of the surveying.

6. The tracking device according to claim 2, further comprising:
a wide-angle image acquisition means configured to acquire an upper wide-angle image and a lower wide-angle image respectively from an upper wide-angle camera arranged at an upper side of a predetermined horizontal plane and a lower wide-angle camera arranged at a lower side thereof,
wherein the image capturing means constitutes the upper camera with a virtual camera configured to acquire an upper camera image in an arbitrary direction from the acquired upper wide-angle image, and the lower camera with a virtual camera configured to acquire a lower camera image in an arbitrary direction from the acquired lower wide-angle image; and
the image capturing direction moving means moves the image capturing direction in a virtual image capturing space where the upper camera and the lower camera respectively acquire the upper camera image and the lower camera image respectively from the upper wide-angle image and the lower wide-angle image.

7. The tracking device according to claim 6,
wherein the upper wide-angle camera and the lower wide-angle camera are respectively an upper full-spherical camera and a lower full-spherical camera.

8. The tracking device according to claim 2,
wherein the mapping means calculates and acquires a location in the upper camera image and the lower camera image of the generated particles by means of a predetermined mapping function.

9. The tracking device according to claim 2, any one of claims 12wherein the image capturing means directs the upper camera and the lower camera to each generated particle, and captures each generated particle; and
the mapping means acquires a location corresponding to the image capturing directions of the upper camera image and the lower camera image as a location of the particles.

10. The tracking device according to claim2, further comprising:
a moving means configured to move with the subject on the basis of the survey result which is output.

11. The tracking device according to claim 2,
wherein the upper camera and the lower camera are arranged on a vertical line.

12. A detection program functioning a computer as a detection device installed in a traveling body, a building structure, or the like, the detection device configured to detect a predetermined subject, the detection program comprising:
an image capturing function configured to captures the subject at a wide angle with an upper camera arranged at an upper side of a predetermined horizontal plane and a lower camera arranged at a lower side of the horizontal plane; and
a detection function configured to detect the captured subject by performing image recognition by using each of an upper camera image of the upper camera and a lower camera image of the lower camera.

13. (canceled)
